(19) United States
(12) Patent Application Publication
(10) Pub. No.: US 2023/0399807 A1
(43) Pub. Date: Dec. 14, 2023

(54) STRUCTURE MANAGEMENT SYSTEM

(71) Applicant: Nippon Telegraph and Telephone Corporation, Tokyo (JP)

(72) Inventors: Shingo Mineta, Tokyo (JP); Shota Oki, Tokyo (JP); Mamoru Mizunuma, Tokyo (JP); Soichi Oka, Tokyo (JP)

(21) Appl. No.: 18/246,995

(22) PCT Filed: Nov. 4, 2020
(86) PCT No.: PCT/JP2020/041170

§ 371 Date: Mar. 28, 2023

(51) Int. Cl. E02D 9/00; B09B 3/70

(52) U.S. Cl. CPC E02D 9/00; B09B 3/70

(57) ABSTRACT

A structure is made of a metal such as a steel material and is buried in the ground. A first wiring is connected to the structure. A second wiring is connected to an electrode. A switch turns on and off a conduction state between the first wiring and the second wiring. In a state where the switch is turned on, the electrode is in a higher potential state as compared to the structure. The electrode can be made of a metal having an ionization tendency lower than that of the metal included in the structure.

### CROSS-REFERENCE TO RELATED APPLICATIONS

This patent application is a national phase filing under section 371 of PCT application no. PCT/JP2020/041170, filed on Nov. 4, 2020, which application is hereby incorporated herein by reference in its entirety.

### TECHNICAL FIELD

The present invention relates to a structure management system that manages a metal structure buried in the ground.

### BACKGROUND

There are many types of infrastructure facilities that support our life, and the number of infrastructure facilities is also enormous. In addition, infrastructure facilities are exposed to various environments not only in urban areas but also in mountainous areas, the vicinity of coasts, hot spring areas, cold areas, and the sea and the ground, and deterioration forms and deterioration progress rates vary. For example, metal underground facilities represented by a steel pipe column, a support anchor, and a steel pipe corrode due to contact with soil and deteriorate at different rates depending on external environments (Non Patent Literature 1, Non Patent Literature 2, and Non Patent Literature 3). Therefore, in order to ensure safety in terms of structure and function, these metal underground facilities are generally renewed after being used for a certain period while the deterioration rate is reduced by various anticorrosion methods.

In a case where a metal structure buried in the ground is renewed, firstly, there is a method of removing a metal structure to be renewed from the ground and burying a new structure in the same place. Further, secondly, a method of leaving an object to be renewed in the ground as it is and burying a new structure in another place may be considered. The latter is sometimes adopted in a case where it is environmentally or technically difficult to remove the object to be renewed from the ground, and the cost is often kept low in consideration of the entire work.

In a state where the object to be renewed is buried in the ground as it is, in a case where a new structure is buried, it is necessary to wait for the object to be renewed to corrode and deteriorate over time and to return to so-called soil. Of course, in terms of prevention of pollution of an underground environment, it is important that the object to be renewed returns to the soil. However, there is a concern that it takes a long time until the object to be renewed returns to the soil.

A corrosion rate in general soil is often low, and it is not difficult to imagine a situation where a functional life of the newly-buried structure comes to an end before the object to be renewed returns to the soil. In this case, the number of structures left in the soil increases, and as a result, there is a high likelihood of reduction in areas for new construction and safety problems occurring. Therefore, it is necessary to shorten a period from when the metal structure buried in the ground becomes unnecessary to when the metal structure returns to the soil. However, it is difficult to shorten the period since the corrosion rate in the soil is low.

### CITATION LIST

### Non Patent Literature

Non Patent Literature 1: Morio KADOI et al., “Studies on Soil Corrosion of Metallic Materials (Part 1)—Fundamental Experiment on Soils-”, CORROSION ENGINEERING, Vol. 16, No. 6, p. 238-246, 1967.
Non Patent Literature 2: Yoshikazu MIYATA and Shukuji ASAKURA, “Corrosion Monitoring of Metals in Soils by Electrochemical and Related Methods (Part II)—Estimation of the Corrosion Rate Based upon the Combination of a Number of Information and Proposals of the Systematic Evaluation Process-”, Zairyo-to-Kankyo, Vol. 46, No. 10, p. 610-619, 1997.
Non Patent Literature 3: Satomi TSUNODA and Tetsuro AKIBA, “Some Problems for Evaluating Soil Aggressivity”, CORROSION ENGINEERING, Vol. 36, No. 3, p. 168-177, 1987.

### SUMMARY

### Technical Problem

As described above, in a case where a new structure is buried when an object to be renewed is buried in the ground as it is, in a method using a normal corrosion rate in the soil, there is a problem that a period from when a metal structure to be renewed becomes unnecessary to when a metal structure to be renewed returns to the soil due to corrosion becomes long.

Embodiments of the present invention have been made to solve the above problems, and an embodiment of the present invention is to more quickly return a metal structure buried in the ground to the soil.

### Solution to Problem

According to embodiments of the present invention, there is provided a structure management system including: a structure that is made of a metal and is buried in the ground; a first wiring that is connected to the structure; an electrode that is made of a metal and is buried in the ground in which the structure is buried; a second wiring that is connected to the electrode; and a switch that turns on and off a conduction state between the first wiring and the second wiring, in which the electrode is in a higher potential state as compared to the structure, in a state where the switch is turned on, and in which a distance between the structure and the electrode is within a range in which electrons generated when the metal included in the structure is ionized are capable of reaching the electrode.

### Advantageous Effects of Embodiments of the Invention

As described above, according to embodiments of the present invention, the electrode is buried around the metal structure which is buried in the ground and the electrode is caused to be in a higher potential state as compared to the structure. Thereby, the metal structure which is buried in the ground can be more quickly returned to the soil.

### BRIEF DESCRIPTION OF THE DRAWINGS

FIG. 1 is a configuration diagram illustrating a configuration of a structure management system according to a first embodiment of the present invention.

FIG. 2 is a configuration diagram illustrating a configuration of a structure management system according to a second embodiment of the present invention.

### DETAILED DESCRIPTION OF ILLUSTRATIVE EMBODIMENTS

Hereinafter, a structure management system according to embodiments of the present invention will be described.

### First Embodiment

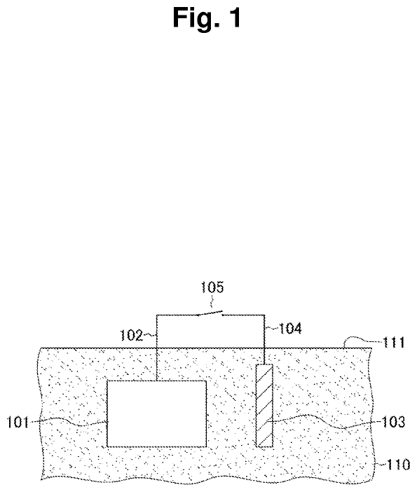

First, a structure management system according to a first embodiment of the present invention will be described with reference to FIG. 1. The structure management system includes a structure 101, a first wiring 102, an electrode 103, a second wiring 104, and a switch 105.

The structure 101 is made of a metal such as a steel material and is buried in the ground. The structure 101 is, for example, a metal pipe, is made of, for example, steel or brass, and has high strength required as a structure 101 used for a building or the like. Further, the structure 101 is inexpensive, generally corrodes due to oxidation, and eventually returns to so-called soil.

The first wiring 102 is connected to the structure 101. The first wiring 102 can be a coated conductive wire. The electrode 103 is made of metal and is buried in the ground in which the structure 101 is buried. The second wiring 104 is connected to the electrode 103. The second wiring 104 can be a coated conductive wire. The switch 105 turns on and off a conduction state between the first wiring 102 and the second wiring 104. In this example, the structure 101 and the electrode 103 are buried in the soil 110.

In addition, in a state where the switch 105 is turned on, the electrode 103 is in a higher potential state as compared to the structure 101. In the first embodiment, the electrode 103 is made of a metal having an ionization tendency lower than that of the metal included in the structure 101. For example, in a case where the structure 101 is made of a steel material, the electrode 103 can be made of nickel, copper, tin, silver, gold, platinum, or an alloy including these materials. In addition, a metal structurally including these metals can be used as the metal used for the electrode 103. With this configuration, when the switch 105 is turned on, the electrode 103 is brought in a higher potential state as compared to the structure 101. In addition, a distance between the structure 101 and the electrode 103 is within a range in which electrons generated when the metal of the structure 101 is ionized can reach the electrode 103.

Next, a structure management method using the structure management system according to the first embodiment will be described. First, one end of the first wiring 102 is electrically connected to the structure 101, and the structure 101 is buried in the soil 110. The other end of the first wiring 102 is exposed on a ground surface 11. Further, one end of the second wiring 104 is electrically connected to the electrode 103, and the electrode 103 is buried in the soil 110. The other end of the second wiring 104 is exposed on the ground surface 111. The other end of the first wiring 102 exposed on the ground surface in and the other end of the second wiring 104 are connected to the switch 105. In the soil 110, the distance between the structure 101 and the electrode 103 is within a range in which electrons generated when the metal of the structure 101 is ionized can reach the electrode 103.

During a period for which the structure 101 is used, the switch 105 is turned off. In this state, the structure 101 deteriorates at a normal soil corrosion rate. After the structure 101 is used for a predetermined period, the switch 105 is turned on in a stage where the structure 101 is renewed.

In this state, the structure 101 and the electrode 103 are electrically connected to each other via the first wiring 102 and the second wiring 104. The structure 101 serves as a negative electrode, and the electrode 103 serves as a positive electrode. Thereby, the soil 110 between the structure 101 and the electrode 103 configures a chemical battery that functions as an electrolyte and a separator. For this reason, corrosion (oxidation) of the structure 101 progresses faster than a normal corrosion (oxidation) rate of the soil 110.

As described above, according to the first embodiment, by turning on the switch 105, even in a case where the structure 101 to be renewed is left buried in the soil 110, the structure 101 can be corroded in a short period of time. Thus, a problem in environment and safety and a cost can be reduced.

Note that a shape of the structure 101 is not particularly limited. Similarly, a shape of the electrode 103 is not particularly limited. In addition, the electrode 103 has a shape that is easily driven into the soil 110, for example, a net shape, a stake shape, or a plate shape. Thus, the electrode 103 is easily buried in the soil 110. In addition, since the electrode 103 has the shape, the electrode 103 can be easily collected. Further, a plurality of electrodes 103 can be buried so as to surround the periphery of the structure 101. This configuration is preferable because the progress of corrosion described above is stabilized.

### Second Embodiment

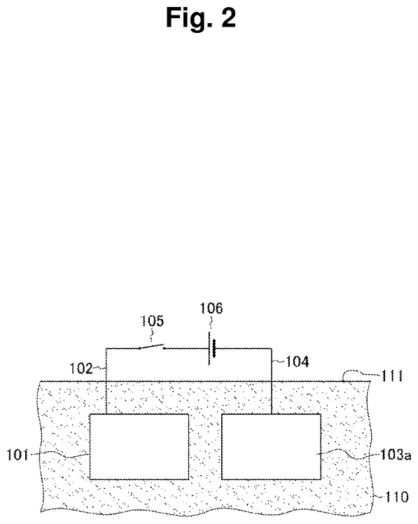

Next, a structure management system according to a second embodiment of the present invention will be described with reference to FIG. 2. The structure management system includes a structure 101, a first wiring 102, an electrode 103a, a second wiring 104, a switch 105, and a DC power supply 106. In a state where the switch 105 is turned on, a negative electrode of the DC power supply 106 is connected to the electrode 103a, and a positive electrode of the DC power supply 106 is connected to the structure 101.

In the second embodiment, when the switch 105 is turned on by the DC power supply 106, the structure 101 is polarized at a potential lower than a potential of the electrode 103a. In a case where the switch 105 is turned on, an output voltage of the DC power supply 106 is adjusted such that a current flows from the structure 101 toward the electrode 103a via the soil 110. In the second embodiment, the electrode 103a can be made of a metal having the same ionization tendency as the metal of the structure 101.

The DC power supply 106 can be a chemical battery or a solar battery. Further, as the DC power supply 106, for example, renewable energy such as solar power generation or wind power generation can be used. Further, in a case where the renewable energy is AC, a rectifier is used to generate DC. Further, the renewable energy can be used by being stored in a storage battery. Other configurations are similar to the configurations of the first embodiment described above.

Also in the second embodiment, first, one end of the first wiring 102 is electrically connected to the structure 101, and the structure 101 is buried in the soil 110. The other end of the first wiring 102 is exposed on a ground surface 11. Further, one end of the second wiring 104 is electrically connected to the electrode 103a, and the electrode 103a is buried in the soil 110. The other end of the second wiring 104 is exposed on the ground surface 111. The other end of the first wiring 102 exposed on the ground surface in and the other end of the second wiring 104 are connected to the switch 105 and the DC power supply 106. In the soil 110, the distance between the structure 101 and the electrode 103a is within a range in which electrons generated when the metal of the structure 101 is ionized can reach the electrode 103a.

During a period for which the structure 101 is used, the switch 105 is turned off. In this state, the structure 101 deteriorates at a normal soil corrosion rate. After the structure 101 is used for a predetermined period, the switch 105 is turned on in a stage where the structure 101 is renewed.

In this state, the structure 101 and the electrode 103a are connected to the DC power supply 106 via the first wiring 102 and the second wiring 104, and a current flows from the structure 101 toward the electrode 103a via the soil 110. For this reason, corrosion (oxidation) of the structure 101 progresses faster than a normal corrosion (oxidation) rate of the soil 110.

As described above, also in the second embodiment, by turning on the switch 105, even in a case where the structure 101 to be renewed is left buried in the soil 110, the structure 101 can be corroded in a short period of time. Thus, a problem in environment and safety and a cost can be reduced.

In addition, the structure management system according to the second embodiment can include any one of a voltmeter, an ammeter, and a coulomb meter connected to the first wiring 102 or the second wiring 104. With this configuration, in a corrosion period after the structure 101 becomes unnecessary, it is possible to estimate a corrosion state, a corrosion rate, a corrosion end period, and the like of the structure 101.

Further, in the second embodiment, the electrode 103a can be made of a new structure for renewing the structure 101. The new structure is the same as the structure 101. With this configuration, in a case where the structure 101 is used for a certain period and it is time to renew the structure 101, a new structure is buried in the soil 110 at a place different from the place at which the structure 101 is provided. Next, in a state where it is assumed that the newly-buried structure is to be the electrode 103a, the structure 101 to be renewed and the new structure are connected as described with reference to FIG. 2, and the switch 105 is turned on.

As a result, the corrosion rate of the structure 101 to be renewed is increased, and the corrosion period is shortened.

Further, at the same time, the newly-buried structure can be prevented from being corroded by an anticorrosion current flowing from the structure 101.

As described above, according to embodiments of the present invention, the electrode is buried around the metal structure which is buried in the ground and the electrode is caused to be in a higher potential state as compared to the structure. Thereby, the metal structure which is buried in the ground can be more quickly returned to the soil.

Note that the present invention is not limited to the embodiments described above, and it is obvious that many modifications and combinations can be implemented by those skilled in the art within a technical scope of the present invention.

### REFERENCE SIGNS LIST

| | |
|---|---|
| 101 | structure |
| 102 | first wiring |
| 103 | electrode |
| 103a | electrode |
| 104 | second wiring |
| 105 | switch |
| 106 | DC power supply |
| 110 | soil |
| 111 | ground surface |

1.-4. (canceled)

5. A structure management system comprising:
a first wiring connected to a structure that is buried underground, wherein the structure comprises a first metal;
a second wiring connected to an electrode that is buried underground within a predetermined distance of the structure, wherein the electrode comprises a second metal, and wherein the predetermined distance between the structure and the electrode is a distance within a range in which electrons generated during ionization of the first metal of the structure are capable of reaching the electrode; and
a switch connected to the first wiring and the second wiring, wherein the switch is configured to turn on and off a conduction state between the first wiring and the second wiring, and wherein, in a state in which the switch is turned on, the electrode is in a higher potential state as compared to the structure.

6. The structure management system according to claim 5, wherein the second metal of the electrode has an ionization tendency that is lower than an ionization tendency of the first metal of the structure.

7. The structure management system according to claim 5, wherein the structure and the electrode are buried underground in soil.

8. The structure management system according to claim 7, further comprising a DC power supply comprising a negative electrode connected to the electrode in the state where the switch is turned on and a positive electrode connected to the structure in the state where the switch is turned on, wherein in the state where the switch is turned on, a current is configured to flow from the structure toward the electrode via the soil.

9. The structure management system according to claim 5, further comprising a voltmeter, an ammeter, or a coulomb meter connected to the first wiring or the second wiring.

10. The structure management system according to claim 5, wherein the electrode comprises a plurality electrodes, wherein the plurality of electrodes is buried underground surrounding the structure.

11. A method of operating a structure management system comprising:
connecting a first end of a first wiring to a structure, the structure comprising a first metal;
burying the structure underground, wherein a second end of the first wiring extends above a ground surface;
connecting a first end of a second wiring to an electrode, the electrode comprising a second metal;
burying the electrode underground within a predetermined distance of the structure, wherein the predetermined distance between the structure and the electrode is a distance within a range in which electrons generated during ionization of the first metal of the structure are capable of reaching the electrode, and wherein a second end of the second wiring extends above the ground surface; and
connecting a switch to the second end of the first wiring and to the second end of the second wiring, wherein the switch turns on and off a conduction state between the first wiring and the second wiring, and wherein, in a state in which the switch is turned on, the electrode is in a higher potential state as compared to the structure.

12. The method according to claim 11, wherein the second metal of the electrode has an ionization tendency that is lower than an ionization tendency of the first metal of the structure.

13. The method according to claim 11, wherein the structure and the electrode are buried underground in soil.

14. The method according to claim 13, further comprising connecting a DC power supply to the switch, wherein, in the state in which the switch is turned on, the DC power supply comprises a negative electrode connected to the electrode and a positive electrode connected to the structure, and a current from the structure toward the electrode flows via the soil.

15. The method according to claim 11, further comprising connecting a voltmeter, an ammeter, or a coulomb meter to the first wiring or the second wiring.
